(19) United States
(12) Patent Application Publication
(10) Pub. No.: US 2024/0424567 A1
(43) Pub. Date: Dec. 26, 2024

(54) SYSTEMS AND METHODS FOR HANDLING COMPONENTS IN AN ISOLATED ENVIRONMENT FOR ADDITIVE MANUFACTURING

(71) Applicant: VulcanForms Inc., Burlington, MA (US)

(72) Inventors: Raghav Aggarwal, Somerville, MA (US); William Curtis Stone, Tewksbury, MA (US)

(73) Assignee: VulcanForms Inc., Burlington, MA (US)

(21) Appl. No.: 18/750,617

(22) Filed: Jun. 21, 2024

Related U.S. Application Data
(60) Provisional application No. 63/510,088, filed on Jun. 23, 2023.

(51) Int. Cl. B22F 12/00; B22F 10/32; B22F 12/88; B33Y 10/00; B33Y 30/00; B33Y 40/00

(52) U.S. Cl. CPC B22F 12/38; B22F 10/32; B22F 12/88; B33Y 10/00; B33Y 30/00; B33Y 40/00

(57) ABSTRACT

Systems and methods for providing a component to and/or removing a component from a printer enclosure of an additive manufacturing system. A chamber may be configured to removably receive and hold a component such as a build volume having a build surface on which a manufactured part is to be formed. One or more portions of the chamber may interact with the component to define a sealed internal space that may be isolated from an external environment and/or purged with inert gas. The chamber and component may be moved independent of a printer enclosure while the sealed internal space is isolated, and the chamber and printer enclosure may sealingly engage for transfer of the component from the chamber into and/or out of the printer enclosure.

### RELATED APPLICATIONS

This application claims priority under 35 U.S.C. § 119(e) to U.S. Provisional Application No. 63/510,088, filed Jun. 23, 2023, the content of which is incorporated by reference in its entirety for all purposes.

### FIELD

Inventive features relate to apparatus and methods for handling components in an isolated environment for additive manufacturing, such as handling a build surface in an isolated environment for provision to and removal from an additive manufacturing system.

### BACKGROUND

Additive manufacturing systems have been employed to generate parts from a variety of materials. In particular, laser powder bed fusion has been employed to melt and fuse powder material together by spreading the material on a build platform and fusing the material together through the use of lasers. The process of spreading material on a build platform and fusing the material together may be repeated until a part with desired characteristics is generated.

### SUMMARY

In some cases, additive manufacturing systems produce a printed part on a build surface while the build surface is located in a controlled environment, such as in a printer enclosure that is purged of air or other non-inert gasses. The controlled environment may be necessary to avoid imperfections or other damage to a printed part, e.g., caused by oxidation, and/or to help prevent creating explosive conditions whereby heated powder material used in the manufacturing process ignites upon exposure to oxygen. Establishing the controlled environment in the printer enclosure can be costly and/or time consuming, such as in cases where the printer enclosure is relatively large and must be purged of air or other unwanted gasses. In addition, or alternatively, a printed part supported on a build surface may be formed at relatively high temperatures and/or using materials that are reactive to oxygen and/or other non-inert gasses. Thus, the printed part may need to be isolated from air after it is formed, e.g., at least until the printed part has cooled to below a threshold temperature. However, cooling a printed part in a printer enclosure may prevent use of the printer enclosure to form additional parts during the cooling period. The inventors have appreciated that it may be desirable to provide a build surface to a printer enclosure, and/or remove a build surface from a printer enclosure, with the build surface in an isolated environment. This can allow, for example, the build surface to be provided to and/or removed from the printer enclosure while the printer enclosure remains purged of non-inert gasses and/or the build surface is maintained in an isolated environment.

According to some aspects of the disclosure, an additive manufacturing system may include a printer enclosure in which an additive manufacturing process is performable to create a printed part. The printer enclosure may include a doorway and a door for accessing the interior volume of the printer enclosure, where the door is movable between an open position and a closed position to open and close the doorway. The additive manufacturing system may also include a chamber having an opening that is removably attachable to the printer enclosure at the doorway. The chamber may have a chamber space accessible through the opening to hold a component (e.g., a build volume) which is usable in the printer enclosure in an additive manufacturing process. After mating of the chamber with the printer enclosure, the chamber space may be purged of air or other unwanted gasses, and the printer enclosure door may be opened so the component can be moved into the printer enclosure. In some cases, the chamber may hold the component such that at least a part of the component, e.g., a build surface of a build volume, is isolated from an external environment, including an environment in the chamber space. This may allow the component part to be held in a sealed internal space while supported by the chamber, and may permit the component to be provided to the printer enclosure in a pre-purged state and/or to be removed from the printer enclosure while held in an isolated environment. The printer enclosure and chamber may be configured to sealingly engage at the doorway and the chamber opening such that the volume of the printer enclosure and the chamber space can be connected together and isolated from the external environment. The component may be movable between the chamber space and the printer volume when the printer enclosure and chamber are engaged and when the door of the printer enclosure is in the open position. Since at least a part of the component may be held by the chamber in an isolated environment, the component may be provided to the printer enclosure in a condition ready for use in the printer enclosure, e.g., heated to a temperature suitable for part formation in the additive manufacturing process, and/or the component may be removed from the printer enclosure while held in an environment to help prevent damage to the part and/or so as to avoid creating dangerous conditions, e.g., the component can be held in an inert gas environment that helps prevent part oxidation and/or avoid exposing hot powder material to potentially explosive conditions. In addition, or alternately, since the chamber may be coupled to the printer enclosure with the component part held in an isolated environment, purging of the chamber space may be performed more rapidly and using less inert gas.

According to some aspects of the disclosure, an assembly for use in an additive manufacturing system may include a chamber having an opening and a chamber space accessible through the opening. The chamber may be configured to engage and form a seal with a corresponding printer enclosure, e.g., at a doorway of the printer enclosure. The assembly may also include an upper interface and a lower interface each within the chamber space, where the upper and lower interfaces are configured to engage with upper and lower portions of a build volume, respectively, to provide a seal with the build volume. The upper and lower interfaces may define a sealed volume or space with the build volume, allowing a build surface of the build volume to be held in an isolatable environment. For example, the sealed volume can be purged of air using inert gas so that the build surface is held in an isolated environment. The chamber may be configured to permit the chamber and build volume to be transported, e.g., to and/or from a printer enclosure, while the sealed volume is maintained in an isolated state. This may provide a convenient way to provide the build surface to the printer enclosure in a pre-prepared state for use (e.g., pre-heated and in a purged environment) and/or to remove the build surface and a printed part from the printer enclosure while maintaining the printed part in an isolated environment.

According to some aspects of the disclosure, an assembly configured for use in an additive manufacturing process may include a chamber having an opening and a chamber space accessible through the opening. A build volume may be positioned within the chamber space and the build volume may define an internal space with one or more portions of the chamber and have a build surface located in the internal space on which a printed part is formable during an additive manufacturing process. The internal space of the build volume may be purged with inert gas and isolated from the external environment in the chamber space.

According to some aspects of the disclosure, a method of forming a printed part in an additive manufacturing process includes supporting a build volume within a chamber space of a chamber. The chamber may include an opening through which the chamber space is accessible and the build volume may include a build surface on which the printed part is formable during the additive manufacturing process. The method may further include defining an internal space with the build volume and one or more portions of the chamber, and purging the internal space with an inert gas to isolate the internal space from an external environment in the chamber space.

According to some aspects of the disclosure, a pre-purged build volume may be provided to a printer enclosure of an additive manufacturing system. In some embodiments, a portion of the build volume may be sealed such that an internal space defined at least in part by the build volume is isolated from the external environment, and the internal space may be purged with inert or other non-reactive gas prior to being provided to the printer enclosure. The printer enclosure may include an airlock door or any other sealing device to isolate the printer volume from the external environment. In some examples, the pre-purged build volume may be moved into the printer enclosure when the airlock door is in the open position, and since the build volume is pre-purged with inert gas, the build volume may remain isolated from the surrounding environment.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not necessarily intended to be drawn to scale. In the drawings, like components may be represented by like numerals. For purposes of clarity, not every component may be labeled in every drawing. In the drawings:

FIG. 1 is a schematic view of an additive manufacturing system including a printer enclosure and a chamber in a detached state, according to some embodiments;

FIG. 2 is a schematic view of the additive manufacturing system of FIG. 1, showing the printer enclosure and the chamber in an attached state, according to some embodiments;

FIG. 3 is a schematic view of the additive manufacturing system of FIG. 2, showing a door of the printer enclosure in an open position, according to some embodiments;

FIG. 4 is a schematic view of the additive manufacturing system of FIG. 3, showing interfaces in the chamber in a disengaged state, according to some embodiments;

FIG. 5 is a schematic view of the additive manufacturing system of FIG. 4, showing a build volume positioned within the printer enclosure, according to some embodiments;

FIG. 6 is a schematic view of the additive manufacturing system of FIG. 5, showing the door of the printer enclosure in the closed position, according to some embodiments;

FIG. 7 is a schematic view of the additive manufacturing system of FIG. 6, showing the printer enclosure and the chamber in the detached state, according to some embodiments;

FIG. 8 is a schematic view of a chamber of an additive manufacturing system showing interfaces in the chamber in an engaged state, according to some embodiments;

FIG. 9 is a schematic view of the chamber of FIG. 8, showing interfaces in the chamber in a disengaged state, according to some embodiments;

FIG. 10 is a schematic view of an additive manufacturing system showing a build volume being moved into a printer enclosure, according to some embodiments;

FIG. 11 is a schematic view of an additive manufacturing system showing a printer enclosure and a chamber in a detached state, according to some embodiments;

FIG. 12 is a schematic view of the additive manufacturing system of FIG. 11, showing the printer enclosure and the chamber in an attached state, according to some embodiments;

FIG. 13 is a schematic view of the additive manufacturing system of FIG. 12, showing a door of the printer enclosure in an open position and a build volume positioned within the chamber, according to some embodiments;

FIG. 14 is a schematic view of the additive manufacturing system of FIG. 13, showing the door of the printer enclosure in a closed position and the chamber in a detached state, according to some embodiments; and

FIG. 15 is a method of forming a printed part in an additive manufacturing process, according to some embodiments.

### DETAILED DESCRIPTION

Laser powder bed fusion allows for rapid generation of parts by melting and fusing powder material together through the use of lasers. The powder material may be spread onto a build surface, and an array of lasers may melt and fuse the powder material in a desired pattern to form a layer of a given part. This process may be iteratively performed to yield a part with desired shape, size, material composition, or any other suitable characteristic.

In some embodiments, the powder material is a metal powder such as a titanium alloy, cobalt-chromium alloy, nickel alloy, stainless steel, iron powder, aluminum powder, aluminum alloy, copper, or any other suitable type of metal powder. In some such embodiments, the inventors have used inert gases in a printer enclosure where an additive manufacturing process is to be performed to obtain a controlled environment such that the gasses in the printer enclosure are chemically inactive. The inventors have recognized that the use of inert or otherwise non-reactive gases may limit or prevent resulting impurities in the manufactured metal parts since the inert gases may prevent oxidation that would result from contact of the metal with reactive gases that exist in the surrounding atmosphere. The inert gases may be introduced into the printer enclosure by any suitable conduit or inlet such that the printer enclosure is purged with inert gas while being isolated from the surrounding atmosphere. However, the inventors have found that removal of printed parts from the printer enclosure may permit air or other gas from the surrounding atmosphere containing non-inert gases to enter the printer enclosure, thereby requiring the printer enclosure to be repetitiously purged with inert gases each time a printed part is formed and removed. This may result in increased cost of manufacturing due to the need to use large amounts of inert gases as well as require additional time to allow for purging of the printer enclosure, thereby reducing manufacturing efficiency. In addition, some printed parts may need to be isolated from air or other reactive gasses, at least immediately after manufacture, e.g., because the part itself may react with oxygen or other gasses and/or because the powder material may be explosive or otherwise highly reactive with air at least while at relatively high temperatures. The inventors have also appreciated that providing a build surface or other component to a printer enclosure in a pre-purged, pre-heated or otherwise prepared state may help reduce the time needed between part manufacturing operations and/or reduce an amount of inert gas needed to transfer the build surface into the printer enclosure.

In view of the above, the inventors have found that benefits may be realized by providing a build surface to, or removing a build surface from, an additive manufacturing system with the build surface in an isolated environment, e.g., to limit the amount of purging of a printer enclosure that is necessary, and thus limiting the amount of inert gas that is required, each time a build surface is provided to and/or a printed part is removed from the printer enclosure. In particular, the inventors have found that by transporting a build surface while held in an isolated environment (e.g., via an airlock) into and/or out of a printer enclosure, the printer enclosure may retain a controlled environment (e.g., of inert gas), thereby reducing the amount of inert gas used and reducing the time that is required to purge the printer enclosure during the manufacturing of successive parts. In addition, or alternately, a printed part on a build surface can be removed from the printer enclosure while held in an isolated environment, protecting the printed part and other components, such as unfused powder material on the build surface, from reactive gasses. Thus, oxidation of the printed part or powder material may also be limited or prevented, thereby allowing for the non-used powder material to be reclaimed and/or reaction of the printed part or powder material with air or other gases prevented.

In some embodiments, a build surface can be part of a build volume that may be moved into and/or removed from a printer enclosure. The build surface can be held in a sealed volume that is isolated from an external environment. For example, the build volume can be held in a chamber that may be configured to sealingly engage with a printer enclosure. One or more portions of the chamber can sealingly engage with the build volume to define the sealed volume to limit exposure of one or more components of the build volume (e.g., a build surface including powder material, a printed part, etc.) to the surrounding non-inert atmosphere when the chamber is not sealingly engaged with the printer enclosure. The chamber can be sealingly engaged with the printer enclosure, and a chamber space in which the build volume is held can be purged of air or other reactive gasses. Thereafter, the build volume can be moved from the chamber to the printer enclosure. As will be discussed in greater detail below, the build volume may engage with one or more interfaces of the chamber to define the sealed volume and isolate one or more portions of the build volume from the surrounding atmosphere. The inventors have found that this may allow for the build surface to remain in an inert atmosphere while being moved between the printer enclosure and chamber, as well as allowing the build surface to remain in an inert atmosphere when the chamber itself and/or external portions of the build volume are otherwise exposed to a surrounding environment (e.g., when the chamber is disengaged from the printer enclosure). While an example describing a build surface as a part of a build volume is disclosed above, any suitable component configured for use in an additive manufacturing process may be used in aspects of the disclosure described herein as the disclosure is not so limited.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused with one or more laser energy beams or pixels to form the individual layers of the one or more parts. This process may be continued until the one or more parts are fully formed.

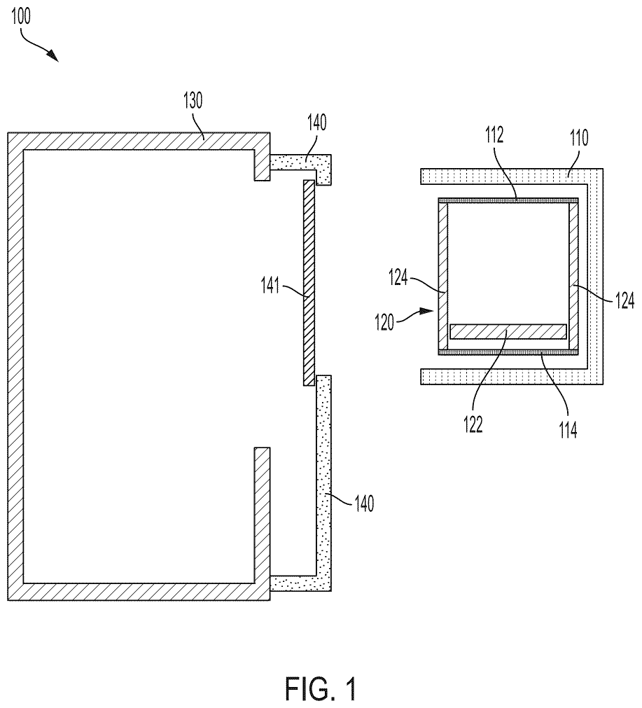

In some embodiments, the additive manufacturing system may undergo a loading sequence in which a component such as a build volume including a build surface and a shroud may be moved from a chamber to the printer enclosure while isolating the component from an external environment. FIGS. 1-7 show an example arrangement of a loading sequence. During the loading sequence, the printer enclosure, the chamber, the build volume, and/or any other suitable parts of an additive manufacturing system may be purged with inert gas and/or isolated from an external environment to retain inert gas.

In FIG. 1, an additive manufacturing system 100 is shown to include a chamber 110 and a printer enclosure 130 initially disengaged from one another. The chamber 110 is configured to removably receive a build volume 120 including a build surface 122 and a shroud 124 within a chamber space accessible through an opening of the chamber 110. In some embodiments, a printed part may be formable on the build surface. While only one opening is shown in the embodiment of FIG. 1, in some embodiments, the chamber may include a plurality of openings as the disclosure is not so limited. The chamber and chamber space may be of any suitable size, shape, or other characteristic to permit the chamber space to removably receive a component which is usable in the additive manufacturing process. For example, the chamber may be configured to support the component above a floor of the chamber. The chamber 110 may contain an upper interface 112 and a lower interface 114 which are configured to engage with upper and lower portions of the build volume 120 or other component, respectively, to define a sealed volume with the build volume 120. The build surface 122 may be contained within the sealed volume, which may be purged of air such as by providing inert gas into the sealed volume. However, the build volume 120 need not necessarily be engaged by the interfaces or other portions of the chamber to define a sealed internal space that can be isolated from an external environment and instead may be simply supported in the chamber 110 and exposed to the environment in the chamber space.

The one or more interfaces 112, 114 may be constructed and arranged in any suitable fashion as the disclosure is not so limited. For example, the one or more interfaces may be constructed as clamping plates that are configured to engage portions (e.g., upper and lower portions) of the build volume to form a gas-tight seal. In particular, the build volume and/or interfaces may have one or more gaskets, and the clamping plates may abut the one or more gaskets in an engaged state such that the seal is formed. The gaskets may be constructed of any suitable material such as silicone as the disclosure is not so limited. In some embodiments, the interfaces may also include one or more protuberances that are configured to abut the one or more gaskets to further promote the gas-tight seal. As disclosed herein, by providing a seal with the build volume, the sealed volume defined by the interfaces and the build volume may remain inert or otherwise isolated from an exterior environment (including an environment in the chamber space) unless the interfaces are disengaged from the build volume.

In FIG. 1, the printer enclosure 130 includes a frame 140 and a door 141 movable relative to the frame 140. In particular, the embodiment of FIG. 1 shows the door 141 in a closed position such that a doorway formed in the frame 140 is closed and a seal is formed between the door 141 and the frame 140. The door 141 may provide a seal on the frame 140 using any one of a variety of suitable sealing mechanisms disclosed herein. For example, a pneumatic actuator may be configured to press the door 141 against one or more gaskets (e.g., via a linkage connected to the pneumatic actuator) to form the seal. The door may be movable between the open and closed positions using any suitable mechanism including, but not limited to a servo driven belt drive, a rack and pinion, pneumatic mechanisms, hydraulic mechanisms, a ball-screw, a lead-screw, or any other suitable mechanism which may move the door between the open and closed positions. In some embodiments, the printer enclosure may have multiple doorways and corresponding doors as the disclosure is not so limited. For example, a first doorway may be used for loading a build volume into the printer enclosure and a second doorway may be used for removing the build volume and manufactured parts from the printer enclosure.

In some embodiments, when the door of the printer enclosure is in the closed position, the door may also be sealed onto a frame of the printer enclosure using a variety of suitable sealing types such as a self-energized elastomeric seal, a spring-energized elastomeric seal, an inflatable elastomeric seal, or any other appropriate type of seal as the disclosure is not so limited. For example, one or more gaskets may be included along the frame of the printer enclosure, and a pneumatic actuator may be configured to press the door against the gasket (e.g., via a linkage connected to the pneumatic actuator) once the door is in the closed position to form a seal. In another example, an inflatable tube may be provided along the door and/or frame of the printer enclosure that may be inflated once the door is in the closed position to form the seal. In another example, the door may be configured to abut the seal as it is moved into the closed position such that no actuation of door against the frame is required (e.g., due to a lower clearance between the door and the frame). While these examples are disclosed, the door may provide a seal on the printer enclosure using any suitable sealing means as the disclosure is not so limited.

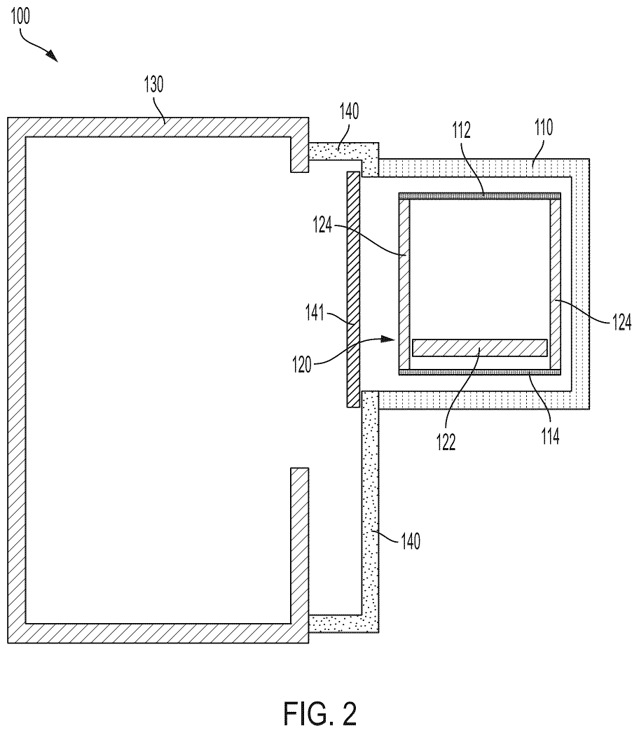

The inventors have also recognized benefits to sealingly engaging a printer enclosure with a corresponding chamber, where a component is removably received within the chamber. For example, in FIG. 2, the chamber 110 is shown to be sealingly engaged with the frame 140 of the printer enclosure 130 such that a seal is formed between the chamber 110 and printer enclosure 130 to isolate their respective internal volumes from the surrounding environment. With the chamber 110 sealingly engaged with the printer enclosure 130, a portion of the chamber space may be purged with inert gas, e.g., by delivering inert gas into the chamber space while venting air or other unwanted gasses. However, as noted above although not required, a sealed volume defined by the build volume 120 and the interfaces 112, 114 may already be purged with inert gas and so need not be purged after the chamber 110 is sealingly engaged with the printer enclosure 130. This may help reduce the amount of inert gas and/or time needed to purge the chamber space for transfer of the build volume 120 into the printer enclosure 130. The build volume 120 or portions of it may be pre-prepared in other ways for introduction into the printer enclosure 130, such as by pre-heating the build surface 122 or other portions in a way suitable for the additive manufacturing process. Pre-heating or other preparation of a build surface 122 may in some cases require that the build surface 122 be held in an isolated environment, e.g., to prevent oxidation of build surface components that may be accelerated by relatively high temperatures. However, holding the build surface 122 or other component in an isolated environment is not necessarily required in all embodiments. Rather, a component may be held in the chamber space and exposed to the environment in the chamber space.

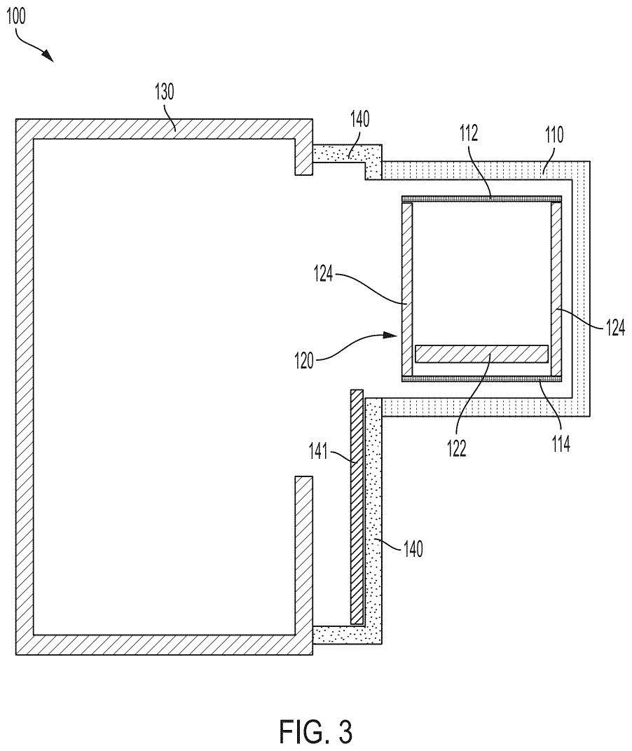

In FIG. 3, with the chamber space purged, the door 141 may be moved to the open position such that the volume of the printer enclosure 130 and the chamber space of the chamber 110 are connected. The seal between the door 141 and the frame 140 may be disengaged prior to moving the door 141 between opened and closed positions. For example, a linkage connected to a pneumatic actuator which presses the door 141 against a gasket on the frame 140 to form a seal may be disengaged, and then the door 141 may be moved from the closed position to an open position.

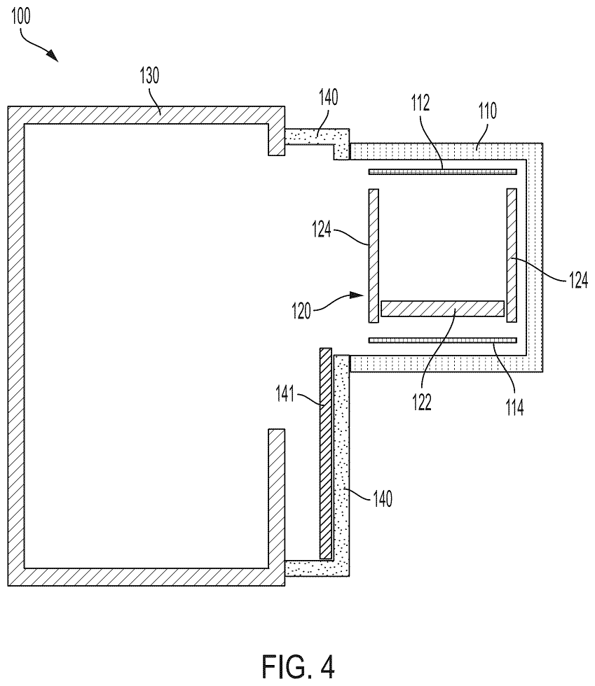

In FIG. 4, with the chamber space purged with inert gas, the upper and lower interfaces 112, 114 may be disengaged from the upper and lower portions of the build volume 120, respectively, if employed. As shown in FIG. 4, the door 141 of the printer enclosure 130 may already be opened, and the build volume 120 may then be moved between the chamber 110 and the printer enclosure 130. The upper and lower interfaces 112, 114 may remain connected to at least one of the walls of the chamber 110 such that the interfaces are retained in the chamber space following disengagement and removal of the build volume 120 from the chamber 110 and movement into the printer enclosure 130.

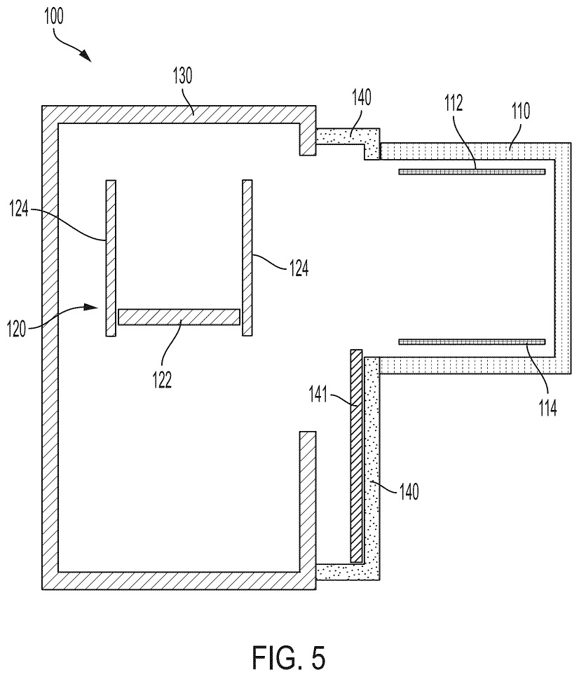

In FIG. 5, the build volume 120 is moved from the chamber space to the volume of the printer enclosure 130 with the door 141 in the open position. The build volume or any other component of an additive manufacturing system may be moved between the chamber and the printer enclosure using a variety of suitable transportation devices such as, for example, a rail system as described in greater detail below, a robotic arm, gantry, or other device. While the upper and lower interfaces 112, 114 remain in the chamber space following removal of the build volume 120 in FIG. 5, in some embodiments, the one or more interfaces may be removably received within the chamber space. For example, the one or more interfaces may be configured to move with the build volume 120 into the printer enclosure 130. In such a case, the interfaces may remain in sealing engagement with the build volume 120 and later removed when the build volume and interfaces are located in the printer enclosure 130.

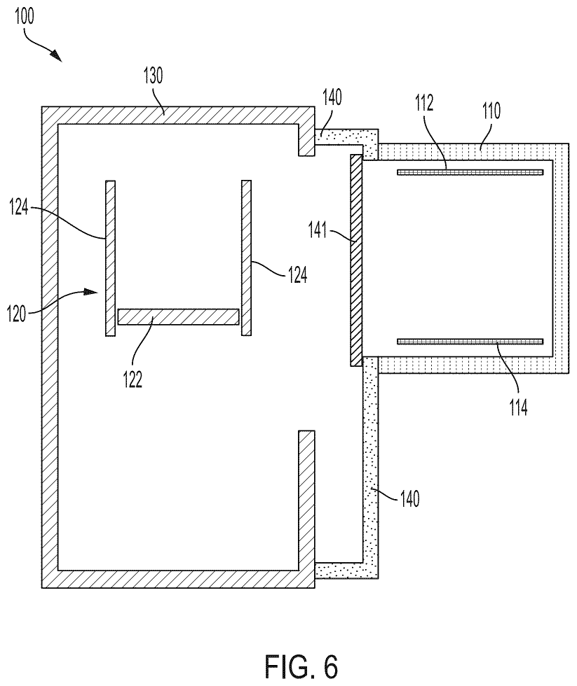

In FIG. 6, the build volume 120 is shown to be retained within the volume of the printer enclosure 130, and the door 141 is shown to be moved back into the closed position such that the doorway is closed. This step ensures that the volume of the printer enclosure 130 is isolated from an exterior environment as the door 141 forms a seal with the frame 140. The build volume 120 may be used to form a printed part in the printer enclosure 130.

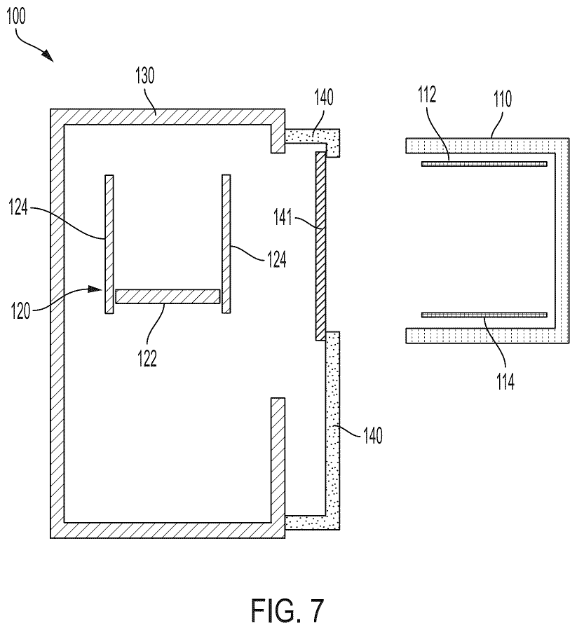

In FIG. 7, with the door 141 closed, the chamber 110 having the upper and lower interfaces 112, 114 may be detached from the frame 140 of the printer enclosure 130. The loading sequence described above in reference to FIGS. 1-7 may ensure that at least a portion of the build volume 120 (such as the build surface) and the volume of the printer enclosure 130 remain in an isolated environment throughout the process of moving the build volume into the printer enclosure. Only a portion of the chamber space need be purged to complete the transfer. Such a configuration negates the need for a multiple chamber airlock system, which is a benefit recognized by the inventors.

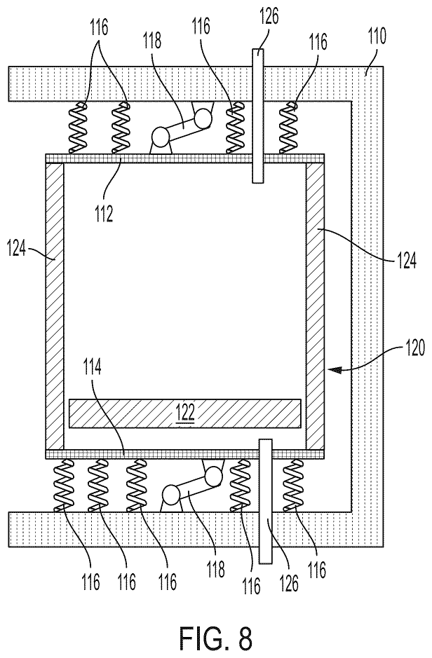

In some embodiments, at least one of the printer volume, the chamber space, and/or an internal space defined at least in part by the build volume may be purged by introducing inert gas into their respective volumes, such as by an inlet and/or conduit communicating with the volumes. For example, as can be seen in FIG. 8, one or more conduits 126 may be coupled to the interfaces 112, 114 to introduce inert gas into and/or vent unwanted gas from a sealed space defined by the build volume and the interfaces 112, 114. The conduits 126 may be configured to permit movement of the interfaces 112, 114 relative to the chamber walls, as discussed more below. Any suitable inert gas may be used to purge the printer enclosure, the chamber space, and/or the build volume including argon, radon, krypton, helium, neon, xenon, nitrogen gas, and carbon dioxide. As disclosed herein, conduits and/or other inlets may be provided on any of the printer enclosure, the chamber, and/or the build volume to allow for spaces to be purged with inert gas to prevent oxidation of the metal powder and the manufactured parts. In some such embodiments, the purging of the printer enclosure volume, the chamber space, and/or the sealed volume formed with the build volume may be done prior to moving a door of the printer enclosure to the open position such that a doorway of the printer enclosure is open. The inventors have recognized that benefits may be realized in such configurations as the printer enclosure volume, the chamber space, and/or the sealed volume may remain purged with inert gases as the build volume is transferred from the chamber 110 to a corresponding printer enclosure. While examples where conduits and/or inlets are used to introduce inert gas into the additive manufacturing system are described above, the components of the additive manufacturing system may be purged in any suitable manner as the disclosure is not so limited. For example, in some embodiments, a chamber may receive a build volume, and the build volume may be introduced to a purged environment in the chamber space without the use of conduits and/or inlets to purge the chamber space.

In some embodiments, one or more sensors may be included with the chamber to detect whether a seal has been sufficiently formed between the build volume and the interfaces. The one or more sensors may detect whether the seal has been formed using pneumatic backpressure ports, e.g., located on the interfaces and/or on the build volume and/or on the chamber. When a pressure within the internal space defined by the interfaces and the build volume reaches a designated threshold, the sensors may indicate that a seal is considered to be suitably formed on the build volume. Pneumatic backpressure ports may also be used on the printer enclosure to detect whether a seal has been formed on the movable door. Thus, the sensing and feedback in the build volume and other components of the additive manufacturing system may be accomplished without using electronic sensing. The inventors have recognized that use of electronic sensing in laser powder bed fusion may be dangerous due to potential contact between hot metal powder in the build volume and the electronic components, which may cause an explosion if the proper safety features are not provided.

In some embodiments, the one or more interfaces of the chamber used to define an internal space with the build volume or other component may be resiliently biased into engagement with corresponding portions of the build volume using one or more biasing members (e.g., springs). For example, the one or more interfaces may include an upper and a lower clamp plate and each of the upper and lower clamp plates may have a plurality of biasing members between the clamp plates and walls of the chamber (e.g., an upper floor and a lower floor of the chamber) so the biasing members bias the upper and lower clamp plates into engagement with upper and lower portions of the build volume, respectively, to form a seal with the build volume. In addition to providing a seal to retain inert gas within an internal space defined with the build volume, the one or more interfaces may also prevent motion of the build volume within the chamber in at least one direction, e.g., during transport of the chamber and build volume. FIG. 8 shows an exemplary embodiment of a build volume 120 which is removably received within a chamber 110. The chamber 110 may include an upper interface 112 and a lower interface 114 which are coupled to walls of the chamber 110 via biasing members 116 and actuators 118. The biasing members 116 may be configured to resiliently bias each of the upper and lower interfaces 112, 114 into engagement with the upper and lower portions of the build volume 120, respectively, whereas the actuators 118 may oppose the biasing force of the biasing members 116 to disengage the upper and lower interfaces 112, 114 from the build volume 120.

In some embodiments, there may be the same number of biasing members between the upper interface and the chamber as there between the lower interface and the chamber. In other embodiments, however, there may be a different number of biasing members used for each of the upper and lower interfaces. For example, the lower interface may be biased by five biasing members while the upper interface may be biased by four biasing members. The inventors have recognized benefits to having a different number of biasing members for each of the upper and lower interfaces, as a greater number of biasing members on the lower interface may counteract the force of gravity and ensure that both the upper and lower interface form a sufficient seal during engagement with the build volume. While the above example is disclosed, the upper and lower interfaces may have any suitable number of biasing members. For example, the upper interface may have three biasing members while the lower interface has four biasing members.

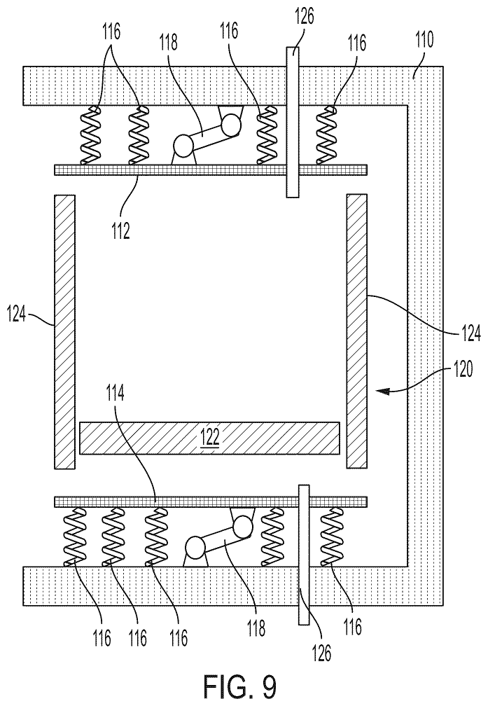

In some embodiments, the one or more interfaces may be disengaged from the build volume through the use of suitable actuators. For example, FIG. 9 shows the FIG. 8 embodiment with the upper and lower interfaces 112, 114 disengaged from the upper and lower portions of the build volume 120, respectively. The actuators 118 may include any suitable actuators, such as pneumatic actuators, as well as any suitable linkages, transmission components, etc. to disengage the upper and lower interfaces 112, 114 from the build volume 120, respectively. Accordingly, the actuators 118 may be configured to overcome the biasing force of the biasing members 116 to disengage the interfaces 112, 114. Upon disengagement of the interfaces 112, 114 from the build volume 120, the build volume may be configured to be moved between the chamber 110 and a corresponding printer enclosure. In some embodiments, the actuation of the actuators may be triggered using a proximity switch which detects when the build volume and/or chamber is in a desired position to disengage the one or more interfaces so that the build volume may be transported into printer enclosure. While the example described above in reference to FIG. 9 depicts a first actuator between a wall of the chamber and the upper interface and a second actuator between a wall of the chamber and the lower interface, respectively, any suitable number of actuators may be provided and arranged in any suitable fashion as the disclosure is not so limited. For example, each of the upper and lower interfaces may be moved by two or more actuators.

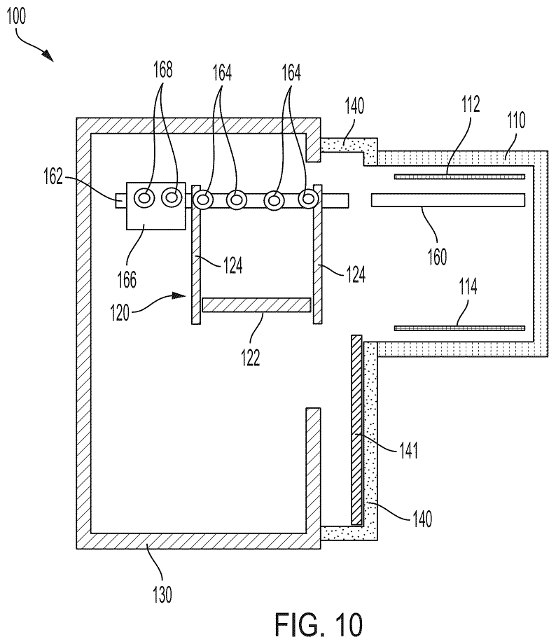

The inventors have recognized that benefits may be realized by employing a rail system to transport a component (e.g., a build volume) of an additive manufacturing system between the chamber and the printer enclosure. For example, in some embodiments, when the door is moved from the closed position to the open position, the build volume may be moved from the chamber to the printer enclosure using a rail system. In such an example, the rail system may be provided in both the printer enclosure and the chamber space. While in some embodiments both the build surface and shroud of a build volume may be movable between the chamber and the printer enclosure, in other embodiments, only the build surface may be movable between the chamber and printer enclosure. An example arrangement of a rail system configured for use in an additive manufacturing system 100 is shown in FIG. 10.

The additive manufacturing system 100 of FIG. 10 depicts a chamber 110 including a chamber rail 160 and a printer enclosure 130 including a printer enclosure rail 162. In some embodiments, the chamber rail 160 and the printer enclosure rail 162 may be collinear to one another and may have a gap disposed between the two rails, as shown in FIG. 10. The build volume 120 may be initially supported on the chamber rail 160 via cam rollers 164 secured to the shroud 124 or other portion of the build volume 120. The build volume 120 may be additionally engaged by a shuttle 166 which may ride on the chamber rail 160 and/or the printer enclosure rail 162 via cam rollers 168. The build volume and/or the shuttle may have any suitable number (e.g., one or more) cam rollers as the disclosure is not so limited. It is also contemplated that other suitable types of couplings may be used to engage the build volume 120 and/or shuttle 166 with the chamber rail 160 and/or printer enclosure rail 162 including, but not limited to any suitable type of wheels, roller or needle bearings, slideways, etc.

In FIG. 10, the shuttle 166 may serve as a transport vehicle and thus may be operatively coupled to the build volume 120, e.g., by connecting to the build surface and/or shroud. The shuttle may include an actuator of any suitable type (e.g., a motor) which may cause the shuttle 166 to move along the chamber rail 160 and/or printer enclosure rail 162, thereby moving the build volume 120 to a desired position. Specifically, the actuator may actuate a rack and pinion or any other suitable drive mechanism to move the shuttle and build volume along the rail system. Notably, the gap between the chamber rail 160 and the printer enclosure rail 162 may be necessitated by the removably engageable nature of the chamber 110 and the printer enclosure 130. Accordingly, the cam rollers 164, 168 of the build volume 120 and the shuttle 166, respectively, may be configured to jump the gap between the chamber rail 160 and the printer enclosure rail 130. In some such embodiments, the shuttle 166 may be exclusively engaged along the printer enclosure rail 162 and configured to engage the corresponding build volume 120 from across the gap to permit movement of the build volume 120 over the gap. In other embodiments, however, the shuttle 166 may be initially situated on the chamber rail 160 and configured to jump the gap between the rails to engage the printer enclosure rail 162.

In FIG. 10, once the build volume 120 reaches a desired position within the printer enclosure 130, the build volume 120 may be removed from the printer enclosure rail 162 such that the build volume 120 is no longer supported by the printer enclosure rail 162. The build volume 120 may then be positioned over or otherwise relative to a build piston (not shown), which may engage the build surface 122 to move the build surface to a desired vertical position during manufacturing. While such an example is disclosed, the shuttle and/or build volume may be engaged or disengaged from the rail system in any suitable fashion as the disclosure is not so limited, or the shuttle and/or build volume may remain engaged with the rail system during manufacturing. Additional layers may also be included between the build piston and the build surface including, but not limited to a heater layer, an insulation layer, a cold plate, etc. While an example arrangement of a rail system has been described above, the inventors have recognized that other suitable devices may be employed to permit movement of a component between a chamber and printer enclosure. For example, a mechanical arm (e.g., a robotic arm) may be configured to grasp a build surface and/or shroud of a build volume to move the build volume between the chamber space and the printer enclosure.

In some embodiments, the chamber and/or the printer enclosure may permit engagement with any suitable pre-processing or post-processing equipment. For example, following the formation of the manufactured part in the printer enclosure, the build volume with the manufactured part may be removed to a chamber that is attached to the printer enclosure. The build volume may be engaged by interfaces of the chamber, e.g., to form a sealed space in which the build surface and printed part are isolated from an exterior environment. The chamber may then be disengaged from the printer enclosure and subsequently interfaced with an article of post-processing equipment. In some embodiments, suitable post-processing equipment may include, but is not limited to heat treating equipment, ultrasonic equipment, electrical discharge machining (EDM) equipment, or any other suitable type, e.g., to clean or otherwise process the printed part. The chamber may also be engageable with pre-processing equipment such as a pre-heating device that heats the build volume, thereby increasing manufacturing speed and preventing oxide film buildup on the build surface.

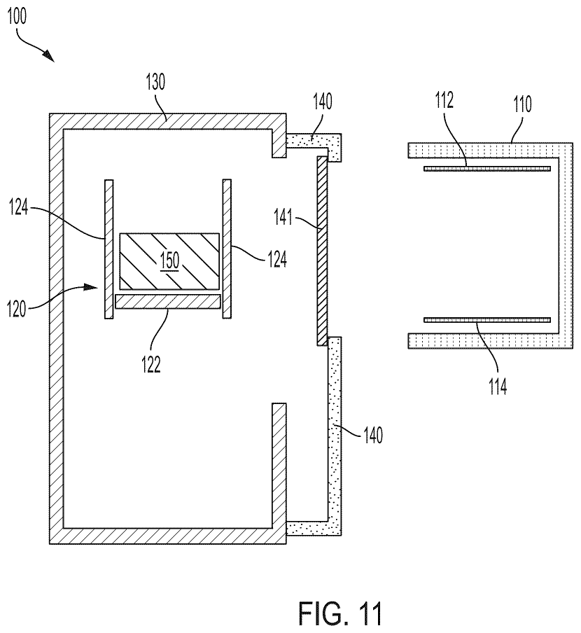

In some embodiments, the additive manufacturing system may undergo an unloading sequence. In an unloading sequence, a component such as a build volume containing a manufactured part may be moved from the printer enclosure to the chamber while isolating the component from the external environment. The build volume may then, for example, be cooled or interfaced with post-processing equipment. FIGS. 11-14 show an example arrangement of an unloading sequence. During the unloading sequence, the printer enclosure, the chamber, the build volume, and/or any other suitable parts of an additive manufacturing system may be or remain purged with inert gas and/or isolated from an external environment to retain inert gas. The unloading sequence may employ similar techniques to that of the loading sequence, and as a result any of the embodiments described above in reference to the loading sequence may be employed for use in the unloading sequence and vice versa as the disclosure is not so limited.

In FIG. 11, a chamber 110 and a printer enclosure 130 are initially detached from one another. The build volume 120 may be initially contained within the printer enclosure 130 and is shown following an additive manufacturing process where the build volume 120 includes a build surface 122 and a shroud 124 as well as a manufactured part 150 which may include unfused powder. The manufactured part 150 and unfused powder may be contained within a space defined by the build surface 122 and the shroud 124. The inventors have recognized that it is advantageous to retain the volume of the printer enclosure 130 and the build volume 120 in an inert atmosphere (e.g., to limit or prevent oxidation of the manufactured part and the metal powder). Thus, the steps of the unloading sequence shown in FIGS. 11-14 may ensure that the printed part 150 as well as the volume of the printer enclosure 130 remain inert.

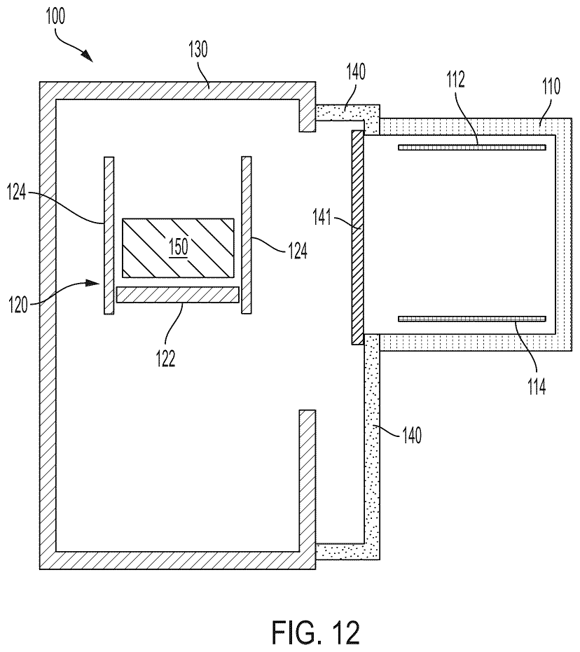

In FIG. 12, the chamber 110 is shown to be sealingly engaged with frame 140 of the printer enclosure 130, while the door 141 remains in the closed position such that the doorway of the frame 140 is closed. Upon the chamber 110 engaging with the frame 140, the chamber 110 may be purged with inert gas prior to the doorway being opened which may ensure that the respective volumes remain inert.

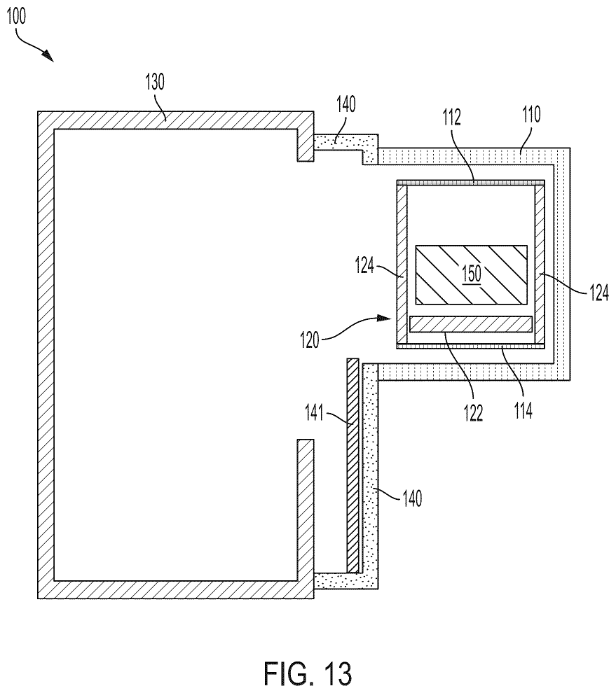

In FIG. 13, the door 141 is shown in the open position such that a doorway of the frame 140 is open. As shown in FIG. 13, the build volume 120 containing the manufactured part 150 and unfused powder may be moved to the chamber space of the chamber 110. Subsequently, the upper interface 112 and the lower interface 114 may be sealingly engaged with the upper and lower portions of the build volume 120 such that the internal space defined by the interfaces and the build volume 120 may be isolated from the external environment. However, this is not required and the build volume 120 may simply be supported in the chamber 110. Where a build volume or other component is held in the chamber and not engaged to define a sealed volume that can be isolated from an environment in the chamber space, the chamber may remain coupled to the printer enclosure and the chamber space isolated and purged, e.g., as a printed part cools to a suitable temperature.

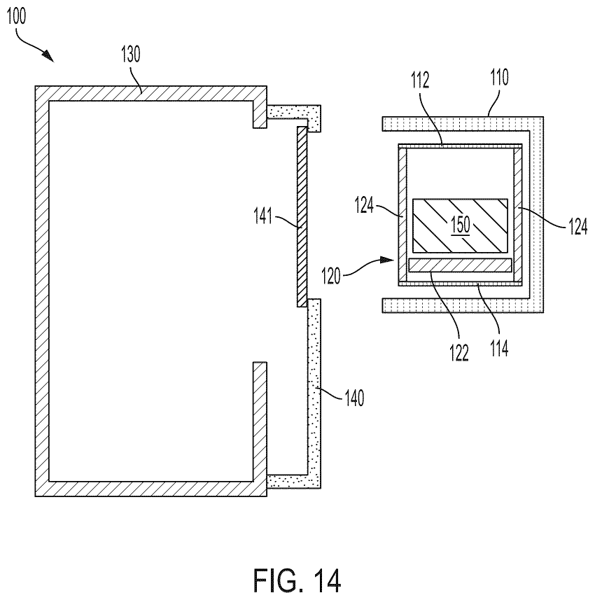

In FIG. 14, the door 141 is shown to be moved back into the closed position such that the doorway of the frame 140 is closed. As shown in FIG. 14, the chamber 110 containing the build volume 120 may then be disengaged from the frame 140 of the printer enclosure 130 at any suitable later time. Thus, both the internal space defined by the interfaces and the build volume 120 and the volume of the printer enclosure 130 remain inert to prevent oxidation of the manufactured part and to limit or prevent loss of inert gas from the printer enclosure volume, respectively. In addition to permitting separation of a printed part and build volume from the printer enclosure, the chamber may permit the printed part and build volume to be transported, e.g., by forklift, truck, etc. for any suitable purpose, such as post-processing at a location physically distant from the printer enclosure. During such transport, the printed part may remain in an isolated environment. In some embodiments, the chamber 110 may be engaged with post-processing equipment as disclosed herein. For example, the manufactured part 150 removably received within the chamber 110 may be subject to heat treatment following manufacturing. As with the printer enclosure, the manufactured part 150 may be moved into a post-processing chamber while remaining in an isolated environment so the post-processing can be performed in a controlled environment.

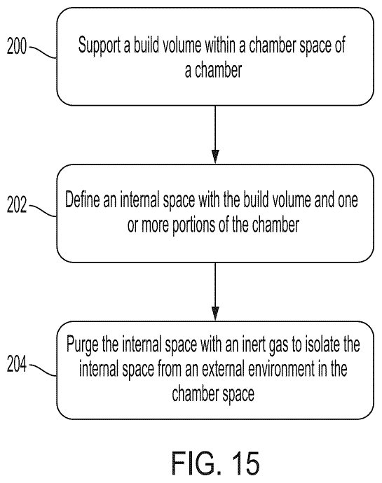

According to some aspects of the disclosure, the embodiments disclosed herein may be embodied as a method. An exemplary method of forming a printed part in an additive manufacturing process is shown in FIG. 15. In step 200, a build volume may be supported within a chamber space of the chamber. The chamber may include an opening through which the chamber space is accessible and the build volume may include a build surface on which a printed is formable during an additive manufacturing process.

In step 202, an internal space may be defined with the build volume and one or more portions of the chamber. In particular, in some embodiments, the internal space may be defined by the sealed volume resulting from engagement of one or more interfaces in the chamber with the build volume.

In step 204, the defined internal space may be purged with inert gas to isolate the internal space from the external environment in the chamber space. For example, the sealed volume formed by engagement of the interfaces with the build volume may be purged with inert gas while the remainder of the chamber space remains non-inert. In some embodiments, the chamber may be sealingly engaged with a corresponding printer enclosure such that the build volume may be movable between the chamber and the printer enclosure. In some embodiments, any of the sealed volume, the chamber space, and/or a volume of the printer enclosure may be purged with inert gas as the disclosure is not so limited.

While an exemplary method has been provided herein in reference to FIG. 15, any embodiments of the disclosure may be embodied as a method as the disclosure is not so limited. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The inventors have realized that the embodiments disclosed herein may provide a variety of benefits when implemented for use in an additive manufacturing process. Such benefits include improved retention of the inert gases in the additive manufacturing system, thereby reducing costs associated with use of the inert gases as well as reducing turnover time for purging the build volume and/or the printer enclosure during manufacturing. Other benefits recognized by the inventors include, but are not limited to that the build volume may be compactly transported while retaining a purged environment within the build volume, thus allowing the build volume to be transported into any enclosure (e.g., the printer enclosure, post-processing equipment, etc.). Moreover, the embodiments disclosed herein may allow for the build volume to be pre-purged and/or pre-heated to improve the speed and efficiency of the manufacturing process, and the manufactured part within the build volume may remain in a purged environment as it is unloaded from the printer enclosure and allowed to cool. The inventors have additionally recognized that traditional airlock systems often require several chambers and doors to ensure sufficient sealing of the target space, which is not required by the present invention. Rather, the embodiments disclosed herein provide the added benefit that only a single door separating the printer enclosure and the chamber may be needed as a space within the build volume may be sealed and purged itself, thereby ensuring that the purged environment is maintained.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system comprising:
a printer enclosure defining a printer volume in which an additive manufacturing process is performable to create a printed part, the printer enclosure including a doorway and a door movable between an open position in which the doorway is open and a closed position in which the doorway is closed; and
a chamber having an opening and removably attachable to the printer enclosure at the doorway, the chamber having a chamber space accessible through the opening to hold a component usable in the printer enclosure in the additive manufacturing process,
wherein the printer enclosure and the chamber are configured to sealingly engage at the doorway and the opening such that the printer volume and the chamber space are isolatable from an external environment and the component is movable from the chamber space to the printer volume with the door in the open position.

2. The system of claim 1, wherein the chamber has only the single opening through which the component is movable into and out of the chamber space.

3. The system of claim 1, wherein the component is a build volume including a build surface on which the printed part is formable during the additive manufacturing process.

4. The system of claim 1, wherein the chamber includes one or more interfaces configured to engage with the component and form a sealed volume with the component.

5. The system of claim 4, wherein the component is a build volume including a build surface on which the printed part is formable during the additive manufacturing process, and wherein the one or more interfaces includes an upper interface configured to engage an upper portion of a build volume in the chamber space to provide a seal on the upper portion of the build volume and a lower interface configured to engage a lower portion of the build volume to provide a seal on the lower portion of the build volume.

6. The system of claim 5, further comprising a first set of biasing members to bias the upper interface into engagement with the upper portion of the build volume, and a second set of biasing members to bias the lower interface into engagement with the lower portion of the build volume.

7. The system of claim 6, further comprising one or more actuators configured to disengage at least one of the upper interface from the upper portion of the build volume and the lower interface from the lower portion of the build volume.

8. The system of claim 7, wherein the one or more actuators includes one or more pneumatic actuators and the first and second sets of biasing members include one or more springs configured to resiliently bias the upper interface and the lower interface, respectively, into engagement with the build volume.

9. The system of claim 1, wherein the chamber includes a floor and is configured to support the component above a floor of the chamber.

10. The system of claim 1, wherein the chamber space is accessible only via the opening.

11. The system of claim 1, further comprising a shuttle configured to move the component between the chamber space and the printer volume.

12. The system of claim 11, wherein the shuttle includes an actuator configured to move the shuttle and the component along a rail to a desired position within the printer volume.

13. The system of claim 1, further comprising a chamber rail in the chamber space configured to support the component for movement along the chamber rail in the chamber space.

14. The system of claim 13, further comprising a printer enclosure rail configured to support the component for movement along the printer enclosure rail in the printer volume, wherein the printer enclosure rail and the chamber rail are configured to support the component for movement between the printer volume and the chamber space with the chamber attached to the printer enclosure and the door in the open position.

15. An assembly configured for use in an additive manufacturing system, the assembly comprising:
a chamber having an opening and a chamber space accessible through the opening, the chamber configured to sealingly engage with an opening of a corresponding printer enclosure in which an additive manufacturing process is to be performed;
an upper interface in the chamber space, the upper interface configured to engage with an upper portion of a build volume to provide a seal with the upper portion of the build volume; and
a lower interface in the chamber space, the lower interface configured to engage with a lower portion of the build volume to provide a seal with the lower portion of the build volume.

16. The assembly of claim 15, wherein the build volume includes a build surface on which a printed part is formable during an additive manufacturing process, and wherein the chamber space is configured to removably receive the build volume such that the build volume is movable from the chamber space to the corresponding printer enclosure when the chamber is sealingly engaged with the printer enclosure.

17. The assembly of claim 15, further comprising a first set of biasing members to bias the upper interface into engagement with the upper portion of the build volume, and a second set of biasing members to bias the lower interface into engagement with the lower portion of the build volume.

18. The assembly of claim 17, further comprising one or more actuators configured to disengage at least one of the upper interface from the upper portion of the build volume and the lower interface from the lower portion of the build volume.

19. The assembly of claim 18, wherein the one or more actuators includes one or more pneumatic actuators and the first and second sets of biasing members include one or more springs configured to resiliently bias the upper interface and the lower interface, respectively, into engagement with the build volume.

20. The assembly of claim 18, wherein the upper interface and the lower interface are configured to be disengaged prior to the build volume being moved from the chamber space to the printer enclosure.

21. The assembly of claim 17, wherein there is a greater number of the one or more biasing members in the second set of biasing members than in the first set of biasing members.

22. The assembly of claim 15, further comprising one or more sensors configured to detect whether the upper and/or lower interfaces are providing the seal with the build volume.

23. The assembly of claim 22, wherein the one or more sensors are configured to detect the seal on the build volume through use of pneumatic backpressure.

24. The assembly of claim 15, wherein at least one of the upper and lower interface includes one or more conduits configured to receive an inert gas to purge an internal space defined by the upper and lower interfaces and the build volume.

25. The assembly of claim 24, wherein the upper portion of the build volume is engaged with the upper interface and the lower portion of the build volume is engaged with the lower interface prior to the inert gas being received to purge the internal space.

26. An assembly configured for use in an additive manufacturing process, the assembly comprising:
a chamber defining a chamber space and having an opening through which to access the chamber space; and
a build volume positioned in the chamber space, the build volume defining an internal space with one or more portions of the chamber and having a build surface on which a printed part is formable during an additive manufacturing process,
wherein the internal space is purged with an inert gas and isolated from an external environment in the chamber space.

27. The assembly of claim 26, further comprising an interface in the chamber space, wherein the interface is configured to engage with the build volume to form a seal with the build volume and define the internal space with the build volume.

28. The assembly of claim 27, wherein the interface includes upper and lower interfaces engaged with upper and lower portions of the build volume, respectively, to define the internal space.

29. The assembly of claim 27, wherein the interface has one or more conduits configured to receive an inert gas to purge the internal space.

30. The assembly of claim 26, wherein the chamber is configured to sealingly engage with an opening of a corresponding printer enclosure in which an additive manufacturing process is performable, and wherein the chamber space is configured to removably receive the build volume such that the build volume is movable from the chamber space to the corresponding printer enclosure when the chamber is sealingly engaged with the printer enclosure.

31. The assembly of claim 26, wherein the chamber is configured support the build volume for transport of the chamber and build volume to a printer enclosure in which the additive manufacturing process is performable.

32. A method of forming a printed part in an additive manufacturing process, the method comprising:
supporting a build volume within a chamber space of a chamber, wherein the chamber includes an opening through which the chamber space is accessible and the build volume includes a build surface on which the printed part is formable during the additive manufacturing process;
defining an internal space with the build volume and one or more portions of the chamber; and
purging the internal space with an inert gas to isolate the internal space from an external environment in the chamber space.

33. The method of claim 32, wherein defining the internal space includes engaging an interface of the chamber with the build volume to form a seal with the build volume and to define the internal space.

34. The method of claim 33, wherein engaging an interface includes engaging upper and lower interfaces with upper and lower portions of the build volume, respectively, to define the internal space.

35. The method of claim 32, further comprising sealingly engaging the chamber with an opening of a printer enclosure defining a printer volume in which the additive manufacturing process is performable, and moving the build volume from the chamber space to the printer enclosure.

36. The method of claim 35, wherein moving the build volume includes moving a door of the printer enclosure to an open position to open a doorway of the printer enclosure, and moving the build volume from the chamber space through the doorway.

37. The method of claim 34, wherein engaging the interface includes resiliently biasing the upper interface into engagement with the upper portion of the build volume, and resiliently biasing the lower interface into engagement with the lower portion of the build volume.

38. The method of claim 37, further comprising disengaging at least one of the upper interface from the upper portion of the build volume and the lower interface from the lower portion of the build volume by opposing a spring force resiliently biasing the upper or lower interface into engagement with the build volume.

39. The method of claim 35, wherein moving the build volume from the chamber space to the printer volume includes moving the build volume along a rail.

40. The method of claim 39, wherein moving the build volume along the rail includes moving the build volume along a chamber rail in the chamber space and along a printer rail in the printer enclosure.

41. The method of claim 34, further comprising transporting the chamber with the build volume supported in the chamber space and the internal space purged and isolated from the external environment in the chamber space to a printer enclosure in which the additive manufacturing process is performable.

42. The method of claim 32, further comprising forming the printed part on the build surface by fusing a powder material deposited on the build surface using one or more laser energy beams.

43. A part manufactured using the method of claim 32.
